(19) United States
(12) Patent Application Publication
(10) Pub. No.: US 2017/0224081 A1
(43) Pub. Date: Aug. 10, 2017

(54) MOTORIZED HAIR DYE MISTING APPLICATOR

(71) Applicant: Paul Jackson, Brunswick, GA (US)

(72) Inventor: Paul Jackson, Brunswick, GA (US)

(21) Appl. No.: 15/019,007

(22) Filed: Feb. 9, 2016

(51) Int. Cl. A45D 24/28; B05B 17/06; A45D 19/00

(52) U.S. Cl. CPC A45D 24/28; A45D 19/00; B05B 17/0676

(57) ABSTRACT

A motorized misting hair dye applicator for dispersing a dye mist throughout the hair of a user employs a comb body having a plurality of teeth which each include an ultrasonic atomizer nozzle integral therewith. The comb body additionally includes a dye distribution system which allows stored liquid dye to be directed from a reservoir to each of the nozzles where the dye can be atomized into a mist. A momentary actuating button provides a manual switching interface which allows a user to selectively operate the dye distribution system so as to control the dispersal of dye mist from the nozzles. When a user combines this misting activity with the simple act of combing the teeth through their hair, the dye mist is dispersed throughout the portion of their hair being combed.

### BACKGROUND OF THE INVENTION

Field of the Invention

This invention relates generally to grooming accessories and, more particularly, to a motorized misting dye application which disperses dye as a mist into a user's hair.

Description of the Prior Art

The use various hair dye application devices to color disperse dye throughout ones hair is well known. A problem which still exists, however, is that existing hair dye applicators, which typically operate to spread a liquid dye, are generally not able to disperse dye evening throughout a user's hair. Thus, there remains a motorized misting hair dye applicator which would allow a user to disperse a dye as a mist through their hair. It would be helpful if such a motorized misting hair dye applicator was structured as a large tooth comb having hollow teeth through which liquid dye could flow. It would be additionally desirable for such a motorized misting hair dye applicator employed an ultrasonic radial spray atomizer nozzles at the end of each tooth to deploy the liquid dye flowing through the tooth as an aerosol.

The Applicant's invention described herein provides for a motorized misting hair dye applicator adapted to allow a user to generate and disperse hair dye as an aerosol directly into their hair. The primary components in Applicant's motorized misting hair dye applicator are a comb body with an internal dye pumping system a plurality of teeth which each include a ultrasonic atomizer nozzle. When in operation, the motorized misting hair dye applicator enables more effective and efficient dispersal of hair dye as a mist through one's hair. As a result, many of the limitations imposed by prior art structures are removed.

### SUMMARY OF THE INVENTION

A motorized misting hair dye applicator for dispersing a dye mist throughout the hair of a user. The motorized misting hair dye applicator comprises a comb body having a plurality of teeth which each include an ultrasonic atomizer nozzle integral therewith. The comb body additionally includes a dye distribution system which allows stored liquid dye to be directed from a reservoir to each of the nozzles where the dye can be atomized into a mist. A momentary actuating button provides a manual switching interface which allows a user to selectively operate the dye distribution system so as to control the dispersal of dye mist from the nozzles. When a user combines this misting activity with the simple act of combing the teeth through their hair, the dye mist is dispersed throughout the portion of their hair being combed.

It is an object of this invention to provide a motorized misting hair dye applicator which would allow a user to disperse a dye as a mist through their hair.

It is another object of this invention to provide a motorized misting hair dye applicator was structured as a large tooth comb having hollow teeth through which liquid dye could flow.

It is yet another object of this invention to provide a motorized misting hair dye applicator employed an ultrasonic radial spray atomizer nozzles at the end of each tooth to deploy the liquid dye flowing through the tooth as an aerosol.

These and other objects will be apparent to one of skill in the art.

### BRIEF DESCRIPTION OF THE DRAWINGS

FIG. 1 is a side elevational view of a motorized misting hair dye applicator built in accordance with the present invention.

FIG. 2 is a front elevational view of a motorized misting hair dye applicator built in accordance with the present invention.

FIG. 3 is a block diagram of the internal components of a motorized misting hair dye applicator built in accordance with the present invention.

### DETAILED DESCRIPTION OF THE INVENTION

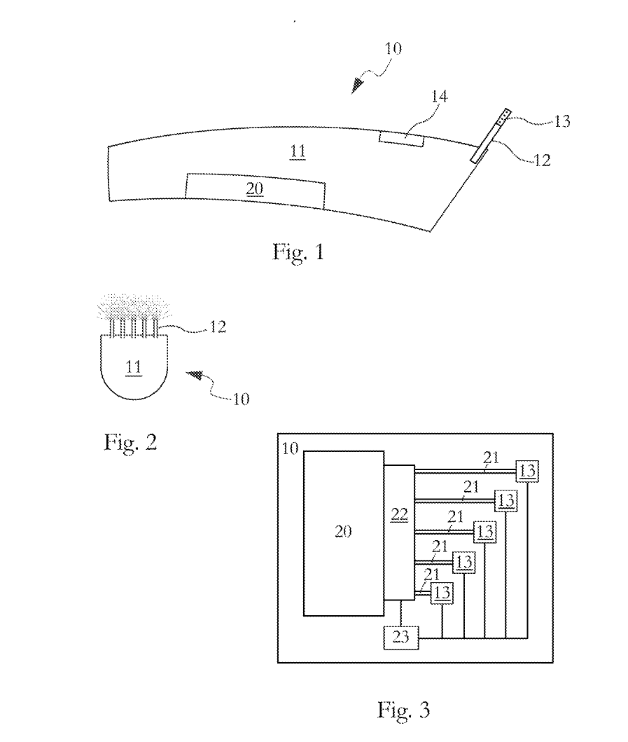

Referring now to the drawings and in particular FIGS. 1, 2 and 3, a motorized misting hair dye applicator 10 is shown having a comb body 11 which includes a plurality of teeth 12. Each of the plurality of teeth 12 include an ultrasonic atomizer nozzle 13 integral therewith. In the preferred embodiment, the nozzle 13 defines a radial spray atomizer nozzle which is operative to disperse an atomized material through small holes therefrom from the sides of the tooth 12.

Internally, the comb body 11 includes a dye distribution system which connects a refillable reservoir 20 with each nozzle 13 by way of a plurality of conduits 21. The dye distribution system additionally includes a motorized pump 22 operative to move liquid hair dye in the reservoir 20 to the nozzles 13, a battery 23 which allows electricity to be provided to the pump 22 as well as the nozzles 13. A momentary actuating button 14 integral with the comb body 11 provides a manual switching interface which allows a user to selectively supply electricity from the battery 23 to the pump 22 and nozzles 13 so as to control the dispersal of dye mist from the nozzles 13.

In operation, by depressing the actuating button 14, electricity is supplied from the battery 23 to both the pump 22 and the nozzles 13. When the pump 22 is supplied with electricity, it directs liquid dye in the reservoir 20 through the conduits 21 to the nozzles 13. When the nozzles 13 are supplied with electricity, they produce vibratory motion which acts to atomize liquid present therein, as with conventional ultrasonic nozzles. Because radial spray nozzles are employed, the atomized liquid is dispersed from the side of the nozzles 13. Thus, by depressing the actuating button 14, a user is able to cause liquid dye from the reservoir 20 to be dispersed out of the sides of the nozzles 13. When a user combines this activity with the simple act of combing the teeth 12 through their hair, dye mist is able to be dispersed throughout their hair.

In the preferred embodiment, it is appreciated that each of the conduits 21 define a tube which connects the reservoir 20 to a single nozzle 13.

In an alternate embodiment, the a removable dye cartridge (not shown) may be employed instead of a refillable reservoir.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A motorized misting hair dye applicator, comprising:
a comb body having a plurality of elongated, hollow teeth, wherein said comb body is adapted to contain liquid hair dye;
at least one atomizer nozzle integral with the plurality of teeth; and
a dye distribution system integral with the comb body, wherein said dye distribution system is operative to selectively direct liquid hair dye contained in the comb body to the at least one atomizer nozzle.

2. The motorized misting hair dye applicator of claim 1, wherein said at least one atomizer nozzle defines an ultrasonic atomizer nozzle and said dye distribution system includes a power source.

3. The motorized misting hair dye applicator of claim 2, wherein said dye distribution system is additionally operative to supply electricity from said power source to said at least one atomizer nozzle, thereby causing said at least one atomizer nozzle to atomize and dispense liquid hair dye directed thereto.

4. The motorized misting hair dye applicator of claim 3, additionally comprising a momentary actuating button integral with said comb body, wherein said momentary actuating button is adapted to enable the selective supply of electricity from said power source to said at least one atomizer nozzle

5. The motorized misting hair dye applicator of claim 2, wherein said dye distribution system employs a motorized pump and said dye distribution system is additionally operative to supply electricity from said power source to said motorized pump in order to selectively direct liquid hair dye contained in the comb body to the at least one atomizer nozzle.

6. The motorized misting hair dye applicator of claim 1, wherein:
said dye distribution system includes a power source and a motorized pump; and
said dye distribution system is additionally operative to supply electricity from said power source to said motorized pump in order to selectively direct liquid hair dye contained in the comb body to the at least one atomizer nozzle.

7. The motorized misting hair dye applicator of claim 1, wherein said comb body includes an internal reservoir which adapts the comb body to contain liquid hair dye.

8. A motorized misting hair dye applicator, comprising:
a comb body having a plurality of elongated, hollow teeth, wherein said comb body is adapted to contain liquid hair dye;
at least one atomizer nozzle integral each of the plurality of teeth; and
a dye distribution system integral with the comb body, wherein said dye distribution system includes a power source and is operative to selectively direct liquid hair dye contained in the comb body to the atomizer nozzles.

9. The motorized misting hair dye applicator of claim 8, wherein atomizer nozzles each define an ultrasonic atomizer nozzle and said dye distribution system is additionally operative to supply electricity from said power source to the one atomizer nozzles, thereby causing each of said atomizer nozzles to atomize and dispense liquid hair dye directed thereto.

10. The motorized misting hair dye applicator of claim 9, wherein said dye distribution system employs a motorized pump and said dye distribution system is additionally operative to supply electricity from said power source to said motorized pump in order to selectively direct liquid hair dye contained in the comb body to the atomizer nozzles.

11. The motorized misting hair dye applicator of claim 10, additionally comprising a momentary actuating button integral with said comb body, wherein said momentary actuating button is adapted to enable the selective supply of electricity from said power source to both said atomizer nozzles and said pump.

12. The motorized misting hair dye applicator of claim 10, additionally comprising a momentary actuating button integral with said comb body, wherein said momentary actuating button is adapted to enable the selective supply of electricity from said power source to both said atomizer nozzles and said pump simultaneously.

13. The motorized misting hair dye applicator of claim 8, wherein said dye distribution system employs a motorized pump and said dye distribution system is additionally operative to supply electricity from said power source to said motorized pump in order to selectively direct liquid hair dye contained in the comb body to the atomizer nozzles.

14. The motorized misting hair dye applicator of claim 8, wherein said comb body includes an internal reservoir which adapts the comb body to contain liquid hair dye.
